(19) United States
(12) Patent Application Publication
(10) Pub. No.: US 2012/0067813 A1
(43) Pub. Date: Mar. 22, 2012

(54) COMPOSITE HOLLOW FIBER MEMBRANE AND METHOD FOR MANUFACTURING THE SAME

(75) Inventors: Moo-Seok Lee, Seoul (KR); JaeHee Ryu, Seoul (KR)

(73) Assignee: KOLON INDUSTRIES, INC., Kwacheon-si, Kyunggi-do (KR)

(21) Appl. No.: 13/264,137

(22) PCT Filed: Apr. 13, 2010
(86) PCT No.: PCT/KR2010/002279

§ 371 Date: Dec. 12, 2011

(30) Foreign Application Priority Data
Apr. 13, 2009 (KR) 10-2009-0031829

(51) Int. Cl. B01D 71/68; B01D 71/28; B05D 7/00; B01D 71/34; B05D 3/02; B05D 3/10; B01D 69/08; B01D 71/56

(52) U.S. Cl. 210/500.23; 427/314

(57) ABSTRACT

A composite hollow fiber membrane and a method for manufacturing the same is disclosed, which is capable of maintaining a peeling strength owing to a low shrinkage rate in hot water, even though a filtering system is used for a long time, whereby the composite hollow fiber membrane can be widely used in a micro-filtration field for producing axenic water, drinking water, super pure water, and so on.

### TECHNICAL FIELD

The present invention relates to a composite hollow fiber membrane and a method for manufacturing the same, which is capable of maintaining a good peeling strength by lowering a hot-water shrinkage rate of a tubular reinforcement therein.

### BACKGROUND ART

A separation method using a membrane has lots of advantages over the method based on heating or phase-changing. Among the advantages is high reliability of water treatment since the water purity required can be easily and stably satisfied by adjusting the size of the pores of a membrane. Furthermore, since the separation method using a membrane does not require a heating process, a membrane can be used with microorganism which is useful for separation process but may be adversely affected by heat.

The separation membrane may include a flat type membrane and a hollow fiber membrane. In case of a hollow fiber membrane module, a separation process is carried out by a bundle of hollow fiber membranes. If considering an effective area for the separation process, the hollow fiber membrane is more advantageous than the flat type membrane.

Conventionally, the hollow fiber membrane has been widely used in a micro-filtration field for producing axenic water, drinking water, super pure water, and so on. Recently, however, the application of the hollow fiber membrane is being expanded to include sewage and waste water treatment, solid-liquid separation in a septic tank, removal of suspended solid (SS) from industrial wastewater, filtration of river, filtration of industrial water, and filtration of swimming pool water.

The hollow fiber membrane may be largely classified into a composite multi-layer membrane and a monolayer membrane; wherein the composite multi-layer membrane is obtained by coating a polymer resin on a surface of a tubular-braid reinforcement prepared from polyester or polyamide fiber, and the monolayer membrane comprises only the polymer resin without reinforcement.

The monolayer membrane may be prepared by a filtration membrane of polyacrylonitrile, cellulose acetate, polyethersulfone, polysulfone, or polyvinylidene difluoride. Especially, the polyvinylidene difluoride is most generally used for the filtration membrane owing to good chemical-resistant and heat-resistant properties. However, the polyvinylidene difluoride is disadvantageous in that it has a low mechanical strength.

The composite multi-layer membrane can realize good mechanical property (strength and elongation) since the composite multi-layer membrane uses the tubular-braid reinforcement. However, a material for the tubular-braid reinforcement is different from a material for the polymer resin coated on the surface of the tubular-braid reinforcement, whereby an adhesive strength therebetween is weakened. Thus, a cleaning process using hot water and a drying process are inevitable for a related art method of manufacturing the composite multi-layer membrane. However, the tubular-braid reinforcement may be shrunk during the cleaning and drying processes, so that the polymer resin may be separated from the tubular-braid reinforcement, or water permeability may be lowered.

Also, if a physical impact, for example, aeration to prevent contamination of the composite multi-layer membrane, is applied to the composite multi-layer membrane at fixed times, the tubular-braid reinforcement and the polymer resin coated thereon are separated from each other, whereby the quality of permeates may be lowered.

### DISCLOSURE OF INVENTION

### Technical Problem

Therefore, the present invention has been made in view of the above problems, and it is an advantage of the present invention to provide a composite hollow fiber membrane and a method for manufacturing the same, which is capable of maintaining a peeling strength owing to a low shrinkage rate in hot water, even though a filtering system is used for a long time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

### Solution to Problem

To achieve these objects and other advantages and in accordance with the purpose of the invention, as embodied and broadly described herein, a composite hollow fiber membrane comprises a tubular reinforcement, and a polymer resin film coated on a surface of the tubular reinforcement, wherein a shrinkage rate in water of 80° C. is not more than 3%.

The tubular reinforcement is prepared by polyethyleneterephthalate fiber, nylon 6 fiber, nylon 66 fiber, or aromatic polyamide fiber.

The polyethyleneterephthalate (PET) fiber and the nylon 66 fiber have crystallinity not less than 45%, the nylon 6 fiber has crystallinity not less than 40%, and the aromatic polyamide fiber has crystallinity not less than 65%.

The tubular reinforcement includes fiber having 0.1 to 7 deniers of single fiber fineness.

The polymer resin film has a thickness of 10 to 200 μm.

The polymer resin film is formed in such a way that an average pore of an outer surface layer is about 0.01 to 1.0 μm, and a diameter of micro pore is gradually increased from the outer surface layer toward an inner surface layer.

The polymer resin film has a pore not more than 10 μm on its cross section.

The polymer resin film is prepared by polyethersulfone, polysulfone, or polyvinylidene difluoride.

In another aspect of the present invention, a method for manufacturing a composite hollow fiber membrane comprises applying a heat treatment for a tubular reinforcement; coating a polymer resin solution on a surface of a heat-treated tubular reinforcement; and coagulating the polymer resin solution coated on the surface of the tubular reinforcement.

The heat treatment for the tubular reinforcement is carried out by a contact with a hot plate maintained at 110 to 230° C.

The process of coating the polymer resin solution on the surface of the heat-treated tubular reinforcement is carried out through the use of a double tubular nozzle, wherein the double tubular nozzle comprises a central tube through which the tubular reinforcement 1 passes; and an outer tube through which the polymer resin solution passes, the outer tube being positioned in the circumstance of the central tube.

The tubular reinforcement is not more than 0.3 g/denier of delivery tension, just before passing through the central tube of the double tubular nozzle.

In addition, the method further comprises cleaning the tubular reinforcement with a polymer resin film formed by the coagulating process.

### Advantageous Effects of Invention

A composite hollow fiber membrane according to the present invention comprises a tubular reinforcement having a low shrinkage rate in hot water, that is, a peeling strength between the tubular reinforcement and a polymer resin film is not lowered even though a filtering system is used for a long time. Especially, if applying the composite hollow fiber membrane of the present invention to a hollow fiber membrane module, the low shrinkage rate in hot water enables to prevent a tension concentration in an adhering portion to a module header, to thereby prevent the composite hollow fiber membrane from being separated from the adhering portion to the module header.

### BRIEF DESCRIPTION OF DRAWINGS

FIG. 1 is a cross section view illustrating a composite hollow fiber membrane according to an embodiment of the present invention.

FIG. 2 is a schematic view illustrating a method for manufacturing a composite hollow fiber membrane according to an embodiment of the present invention.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a composite hollow fiber membrane according to the present invention and a method for manufacturing the same will be explained with reference to the accompanying drawings.

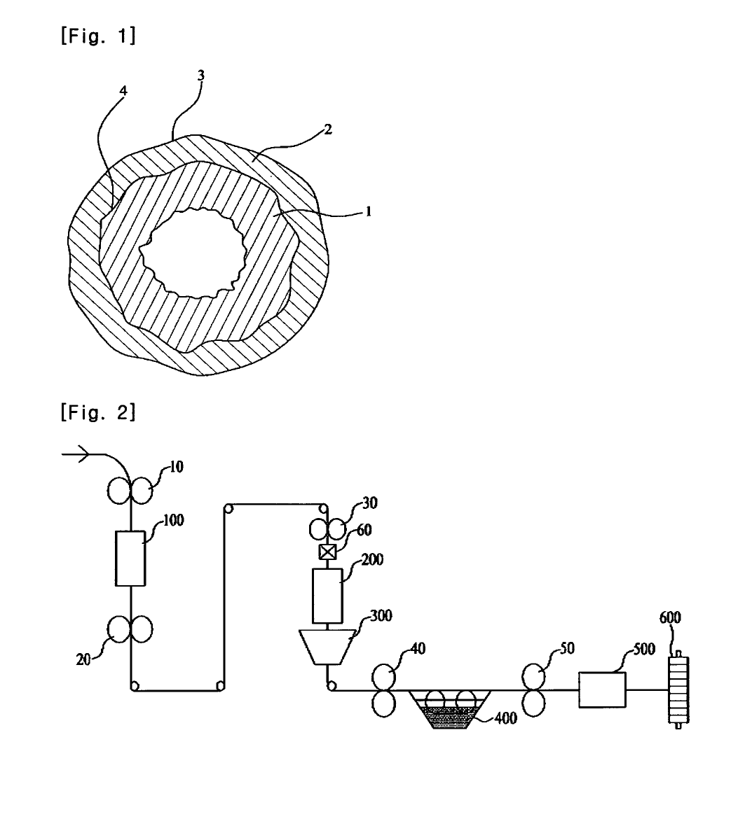

FIG. 1 is a cross section view illustrating a composite hollow fiber membrane according to an embodiment of the present invention.

As shown in FIG. 1, the composite hollow fiber membrane according to an embodiment of the present invention includes a tubular reinforcement 1, and a polymer resin film 2 coated on the surface of the tubular reinforcement 1.

The tubular reinforcement 1 may be prepared by braiding.

The tubular reinforcement 1 may be prepared by using a yarn such as a filament, wherein the tubular reinforcement 1 serves to improve a mechanical property of the composite hollow fiber membrane. The tubular reinforcement 1 may be prepared by the filament yarn or spun yarn using staple. In consideration to a mechanical strength of the composite hollow fiber membrane, the tubular reinforcement 1 is prepared by the filament yarn, preferably.

The tubular reinforcement 1 may be prepared by a fiber having a round type cross section, a non-round type cross section, or a hollow type cross section. If considering an adhesive strength to the polymer resin film, the tubular reinforcement 1 is prepared by the fiber having the non-round type cross section. At this time, the fiber may have 0.1 to 7 deniers of single fiber fineness. If the single fiber fineness is less than 0.1 deniers, a peeling strength is good, but an initial modulus is lowered, so that it is difficult to satisfy the property standard required in the advanced-technology field. In addition, an economical efficiency is lowered due to the increased manufacturing cost. Meanwhile, if the single fiber fineness is more than 7 deniers, the peeling strength in the polymer resin film may be lowered.

For improving the peeling strength of the yarn, the yarn may be a mixed yarn prepared by mixing yarns having the different diameters. That is, the fiber may be the mixed yarn prepared by mixing the large-diameter yarn and the small-diameter yarn together.

A total fineness of the yarn may be 200 to 600 deniers. If the total fineness of the yarn is less than 200 deniers, the yarn might be easily deformed by an external impact, thereby lowering durability. If the total fineness of the yarn is more than 600 deniers, water permeability may be lowered due to the decreased inner diameter of the hollow fiber membrane.

The tubular reinforcement 1 may be prepared by using a synthetic fiber, reproduced fiber, natural fiber, inorganic fiber, or their mixtures. The synthetic fiber may be nylon 6 fiber, nylon 66 fiber, polyamide-based fiber such as aromatic polyamide fiber, polyester-based fiber such as polyethyleneterephthalate fiber, polyacrylonitrile-based fiber, or polyolefine-based fiber. If considering the manufacturing cost, mechanical property, and adhesive strength to the polymer resin film 2, the tubular reinforcement 1 may be prepared by the polyamide-based or polyester-based fiber.

If the tubular reinforcement 1 is prepared by using the polyethyleneterephthalate fiber, nylon 66 fiber, nylon 6 fiber, or aromatic polyamide fiber; the polyethyleneterephthalate fiber and the nylon 66 fiber have crystallinity above 45%, the nylon 6 fiber has crystallinity above 40%, and the aromatic polyamide fiber has crystallinity above 65%. The tubular reinforcement 1 prepared by the fiber having the high crystallinity has great thermal stability and mechanical strength, whereby the peeling strength can be stably maintained without deformation for a long time.

The tubular reinforcement 1 may be a mixed yarn comprising the different components. That is, the tubular reinforcement 1 may be the mixed yarn prepared by mixing the polyester fiber with the nylon fiber. The tubular reinforcement 1 may be the mixed yarn comprising the different kinds of fibers with the different diameters. That is, the tubular reinforcement 1 may be the mixed yarn prepared by mixing the polyester fiber having a single fiber fineness of a small diameter with the polyester fiber having a single fiber fineness of a large diameter.

In order to improve the peeling strength in the polymer resin film 2, the tubular reinforcement 1 may be prepared by a false twisted yarn with a great crimp property.

The composite hollow fiber membrane has a shrinkage rate in water of 80° C. corresponding to 3% or less than. The hot-water shrinkage rate of the composite hollow fiber membrane is largely affected by the hot-water shrinkage rate of the tubular reinforcement 1. In this respect, the tubular reinforcement 1 has the shrinkage rate in water of 80° C. corresponding to 3% or less than. If the tubular reinforcement 1 has more than 3% shrinkage rate in water of 80° C., the tubular reinforcement 1 is rapidly shrunk during a process for manufacturing the composite hollow fiber membrane so that the polymer resin film 2 is separated from the tubular reinforcement 1, whereby filtering reliability might be lowered.

It is preferable that the tubular reinforcement 1 have no fine hairs and loops. If the fine hairs exist on the surface of the tubular reinforcement 1, the composite hollow fiber membrane prepared by using the tubular reinforcement 1 with the fine hairs may have a defective portion so that bacteria and foreign materials might be easily permeated therethrough, to thereby lower filtering reliability.

The polymer resin film 2 has 10 to 200 μm thickness. If the thickness of the polymer resin film 2 is less than 10 μm, the mechanical strength is lowered. Meanwhile, if the thickness of the polymer resin film 2 is above 20 μm, the water permeability is lowered.

The water permeability and filtering reliability in filtration membrane depend on the polymer resin film 2 having a small pore, instead of the tubular reinforcement 1 having a large pore. The polymer resin film 2 is formed in such a way that an average pore of an outer surface layer 3 is about 0.01 to 1.0 μm, and a diameter of micro pore is gradually increased from the outer surface layer 3 toward an inner surface layer 4. The polymer resin film 2 is provided with the outer surface layer 3 with a relatively-compact structure, and the inner surface layer 4 with a relatively-incompact structure, thereby resulting in the improved filtering reliability and water permeability. That is, since the outer surface layer 3 is coagulated more quickly than the inner surface layer 4, the pore of the outer surface layer 3 is relatively smaller than the pore of the inner surface layer 4.

As the polymer resin film 2 has the pore less than 10 μm on its cross section, a finger-like structure is not formed in the polymer resin film 2, whereby the filtering reliability can be improved by filtering out the foreign materials.

The polymer resin film 2 may be polyethersulfone, polysulfone, or polyvinylidene difluoride. The polyvinylidene difluoride makes a great resistance to an oxidizing environment such as ozone used to sterilize water. Also, the polyvinylidene difluoride exhibits good durability even in inorganic acid, organic acid, aliphatic and aromatic hydrocarbon, alcohol, and halide solvents.

A method for manufacturing the composite hollow fiber membrane according to an embodiment of the present invention will be explained with reference to the accompanying drawings.

FIG. 2 is a schematic view illustrating a method for manufacturing the composite hollow fiber membrane according to an embodiment of the present invention.

First, the tubular reinforcement 1 is heat-treated. For improving the thermal stability of the tubular reinforcement 1, and simultaneously flattening the fine hairs and loops on the surface of the tubular reinforcement 1, the heat treatment has to be applied to the tubular reinforcement 1 before coating the tubular reinforcement 1 with polymer resin.

The heat treatment may be directly carried out by using hot water, wherein a hot plate may be used to enhance the yield and property. If using the hot plate, the tubular reinforcement 1 may be indirectly heat-treated by using a high-temperature hollow tube, or may be heat-treated by the direct contact with the high-temperature hot plate. However, a contact-type hot plate may be used for flattening the surface of the tubular reinforcement 1, and improving the thermal efficiency.

The contact-type hot plate may be set at 110 to 230° C. If the temperature of the contact-type hot plate is lower than 110° C., it is difficult to realize the sufficient effect of the heat treatment. Meanwhile, if the temperature of the contact-type holt plate is higher than 230° C., the property may be lowered, and a safety problem may occur.

Then, the heat-treated tubular reinforcement 1 is coated with a polymer resin solution.

The heat treatment of the tubular reinforcement 1 and the process for coating the heat-treated tubular reinforcement 1 with the polymer resin solution may be performed in the same apparatus, or in the different apparatuses.

This process for coating the heat-treated tubular reinforcement 1 with the polymer resin solution can be carried out through the use of a double tubular nozzle, wherein the double tubular nozzle comprises a central tube through which the tubular reinforcement 1 passes; and an outer tube through which the polymer resin solution passes, the outer tube being positioned in the circumstance of the central tube. That is, when the tubular reinforcement 1 heat-treated in a heat treatment unit 100 passes through the central tube of the double tubular nozzle in a spinneret 200, the polymer resin solution corresponding to a spinning dope is fed to the surface of the tubular reinforcement 1 through the outer tube covering the central tube of the double tubular nozzle, whereby the spinning dope is coated on the surface of the tubular reinforcement 1.

The spinning dope can be obtained by dissolving the aforementioned polymer resin solution in an organic solvent. The organic solvent may be dimethyl acetamide, dimethyl formamide, or a mixture thereof.

The spinning dope may include an additive. At this time, polyvinylpyrrolidone and hydrophilic compound can be used as the additive of the spinning dope. The hydrophilic compound is water or glycol compound. Among the glycol compounds is polyethylene glycol having a molecular weight less than 2,000. Since the water or glycol compound, which is hydrophilic, reduces the stability of the spinning dope, it is more likely to form the polymer resin film 2 of a sponge structure. If the spinning dope has the high stability, a pore having a diameter larger than 10 μm is formed on a cross section of the polymer resin film 2, whereby the polymer resin film 2 tends to form a finger-like structure corresponding to defective portions. Accordingly, addition of the hydrophilic compound enables to reduce the stability of the spinning dope, and simultaneously to make the polymer resin film 2 hydrophilic, so that the pore having the diameter larger than 10 μm is not formed on the cross section of the polymer resin film 2, thereby resulting in the improved water permeability.

The spinning dope may be 10 to 50% by weight. If the spinning dope is less than 10% by weight, viscosity is too low to produce the porous composite hollow fiber membrane, and its tensile strength is lowered. Meanwhile, if the spinning dope is more than 50% by weight, viscosity is too high so that the spinning process becomes impossible and porosity of the composite hollow fiber membrane becomes small, whereby the water permeability may be lowered.

Just before passing through the central tube of the tubular nozzle, the tubular reinforcement 1 is less than 0.3 g/denier of delivery tension. If the spinning process is carried out under the condition of high tension, the hot-water shrinkage rate may be increased due to the increased internal tension of inner chains in the tubular reinforcement 1. Accordingly, the tubular reinforcement 1 can be supplied to the double tubular nozzle under the condition of the smooth delivery and appropriate overfeed rate. If the overfeed rate increases, the internal tension is decreased. Meanwhile, if excessively applying the overfeed rate, the smooth delivery of the tubular reinforcement 1 and uniformity of the spinning process cannot be accomplished.

Then, a process for coagulating the polymer resin solution coated on the tubular reinforcement 1 is carried out. This coagulating process is carried out through the use of a coagulating tube 300 filled with a non-solvent to induce a coagulation of the spinning dope. The non-solvent may be at least any one of water, hexane, pentane, benzene, toluene, methanol, ethanol, carbon tetrachloride, and polyethylene glycol.

Then, the composite hollow fiber membrane coagulated through the coagulating tube 300 is cleaned in a cleaning unit 400, dried in a drying unit 500, and then wound in a winding unit 600 provided with a bobbin, whereby the composite hollow fiber membrane is completed. The cleaning process using pure water is performed at a temperature of 40 to 100° C.

Hereinafter, various embodiments and comparative examples of the present invention will be described as follows.

### First Embodiment

First, polyethyleneterephthalate yarn of 525 denier/252 filament is prepared by a general spinning and drawing method, wherein the polyethyleneterephthalate yarn has 11% shrinkage rate in water of 80° C. A tubular reinforcement 1 is prepared, which has an outer diameter of 2.6 mm by braiding the 20 polyethyleneterephthalate yarns.

Then, a spinning dope is prepared, which comprises polyvinylidene difluoride of 30% by weight, polyvinylpyrrolidone of 9% by weight, polyethylene glycol of 10% by weight, and dimethyl formamide of 51% by weight.

The prepared tubular reinforcement 1 is heat-treated at 190° C. hot-plate temperature by 8% overfeed rate. At this time, the overfeed rate is adjusted by setting speeds of first and second rolls 10 and 20, that is, the speed of the first roll 10 is set to be slower than the speed of the second roll 20.

Under the conditions of that the prepared spinning dope is supplied to a double tubular nozzle with a nozzle tip having 2.5 mm inner diameter, and the heat-treated tubular reinforcement 1 passes through a central tube of the double tubular nozzle at 0.05 g/denier of delivery tension; the spinning dope fed from an outer tube of the double tubular nozzle is coated on the surface of the tubular reinforcement 1, and then the tubular reinforcement 1 coated with the spinning dope is extruded to the air. At this time, the spinning dope is coated at 0.15 mm thickness.

Then, the tubular reinforcement 1 coated with the spinning dope passing through an air gap is coagulated in a coagulating tube 300 maintained at 8° C., wherein the coagulating tube 300 is filled with pure water of 80% by weight, and glycerin of 20% by weight; is cleaned in a cleaning unit 400 maintained at 60° C.; is dried in a drying unit maintained at 90° C.; and is wound in a winding unit, to thereby manufacture a composite hollow fiber membrane.

### Second and Third Embodiments

A composite hollow fiber membrane is prepared in the same process and condition as the aforementioned first embodiment except a hot-plate temperature is changed to 150° C. or 220° C.

### Fourth Embodiment

A composite hollow fiber membrane is prepared in the same process and condition as the aforementioned first embodiment except that a tubular reinforcement 1 is heat-treated at 5% overfeed rate.

### Fifth Embodiment

A composite hollow fiber membrane is prepared in the same process and condition as the aforementioned first embodiment except that a tubular reinforcement 1 is prepared by using a nylon 6 yarn of 490 denier/168 filament having 13% shrinkage rate in water of 80° C., prepared by a general method.

### Sixth Embodiment

A composite hollow fiber membrane is prepared in the same process and condition as the aforementioned first embodiment except that a tubular reinforcement 1 is prepared by using an mixed yarn obtained by interlacing a para-based aromatic aramid yarn of 75 denier/35 filament having 0.3% shrinkage rate in water of 80° C. and 71% crystallinity with a polyethyleneterephthalate yarn of 300 denier/144 filament having 11% shrinkage rate in water of 80° C., prepared by a general method.

### Comparative Example

A composite hollow fiber membrane is prepared in the same process and condition as the aforementioned first embodiment except that a tubular reinforcement 1 is not heat-treated.

Hot-Water Shrinktage Rate

An initial length (L0) of sample is measured after applying an initial load of 0.005 g/denier. Then, the sample is dipped into water of 80? for 120 minutes after removing the initial load, and then the water with the sample is boiled. After that, a length (L1) of the sample is measured when the sample is applied to the load of 0.005 g/denier. Then, the measured lengths (L0) and (L1) of the sample are applied to the following math-FIG. 1. The aforementioned process is repeated 5 times or more, and then an average value is calculated.

MathFigure 1

Hot-water shrinkage rate(%)=[(L0−L1)/L0]×100 [Math.1]

Peeling Strength

The load at the moment when the polymer resin film 2 is peeled off from the tubular reinforcement 1 by using a tensile tester is measured and divided into the area m² to which shear strength is applied to calculate the peeling strength.

Detailed measurement conditions are as follows.
measuring instrument: Instron 4303
load cell: 1 KN
crosshead speed: 25 mm/min
grasping distance: 50 mm
sample: the sample was produced by bonding and securing one strand of a composite hollow fiber membrane to a polypropylene tube having a diameter of 6 mm using a polyurethane resin so that the length of the bonding portion be 10 mm.

The peeling strength is defined as the shear strength per unit area applied to the coated polymer resinous film 2 when the sample is extended. The application area (m²) of the shear strength is calculated by the equation: π×outer diameter (m) of composite hollow fiber membrane×length (m) of bonding portion of composite hollow fiber membrane. The peeing strength can be calculated by the following math-figure 2.

$$\begin{matrix} MathFigure 2 & \\ Peeling Strength ( Pa ) = \frac{load of yield point ( kg )}{application area of shear strength ( {m}^{2} )} & [ Math . 2 ]\end{matrix}$$

Crystallinity

A sample is obtained by collecting only the tubular reinforcement 1 from the composite hollow fiber membrane. The crystallinity is calculated by the following math-figure 3.

MathFigure 3

Crystallinity(%)=[(ρ−ρₐ)/(ρ_{c}−ρₐ)]×100 [Math.3]

At this time, ‘ρ’ is a density (g/cm³), ‘ρₐ is an amorphous density, and ‘ρ_{c} is a crystal density. Also, ‘ρ’ is measured by a density gradient tube.

Water Permeability (Lp)

First, four strands of composite hollow fiber membrane and an acryl tube having a diameter of 10 mm and a length of 170 mm are prepared. After the composite hollow fiber membrane is cut to have a length of 160 mm, one end of the composite hollow fiber membrane cut is sealed by an adhesive. After the composite hollow fiber membrane is inserted into the acryl tube, a space between one end of the acryl tube and the composite hollow fiber membrane is sealed. Then, when pure water is put into the acryl tube, and a nitrogen pressure is applied to the acryl tube for 1 minute, an amount of pure water permeated through the composite hollow fiber membrane is measured. A unit of the water permeability (Lp) is (ml/cm²)×(min)×(kg/cm²).

TABLE 1

| | Hot-water | Peeling | | Water |
|---|---|---|---|---|
| | shrinkage | strength | Crystallinity | permeability |
| | rate (%) | (MPa) | (%) | (Lp) |
| Embodiment 1 | 1.26 | 1.11 | 51 | 1.3 |
| Embodiment 2 | 1.85 | 0.98 | 48 | 1.2 |
| Embodiment 3 | 0.33 | 1.12 | 54 | 1.7 |
| Embodiment 4 | 1.58 | 1.10 | 51 | 1.4 |
| Embodiment 5 | 2.57 | 1.14 | 52 | 1.3 |
| Embodiment 6 | 0.78 | 1.22 | 51 | 1.6 |
| Comparative | 5.61 | 0.42 | 41 | 0.3 |
| example | | | | |

As shown in the above table 1, the composite hollow fiber membrane prepared by using the tubular reinforcement 1 heat-treated in the low-tension state can realize the low hot-water shrinkage rate, to thereby result in the enhanced peeling strength and improved water permeability.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A composite hollow fiber membrane comprising:
a tubular reinforcement, and a polymer resin film coated on a surface of the tubular reinforcement,
wherein a shrinkage rate in water of 80° C. is not more than 3%.

2. The composite hollow fiber membrane according to claim 1, wherein the tubular reinforcement is prepared by polyethyleneterephthalate fiber, nylon 6 fiber, nylon 66 fiber, or aromatic polyamide fiber.

3. The composite hollow fiber membrane according to claim 2, wherein the polyethyleneterephthalate (PET) fiber and the nylon 66 fiber have crystallinity not less than 45%, the nylon 6 fiber has crystallinity not less than 40%, and the aromatic polyamide fiber has crystallinity not less than 65%.

4. The composite hollow fiber membrane according to claim 1, wherein the tubular reinforcement includes fiber having 0.1 to 7 deniers of single fiber fineness.

5. The composite hollow fiber membrane according to claim 1, wherein the polymer resin film has a thickness of 10 to 200 μm.

6. The composite hollow fiber membrane according to claim 1, wherein the polymer resin film is formed in such a way that an average pore of an outer surface layer is about 0.01 to 1.0 μm, and a diameter of micro pore is gradually increased from the outer surface layer toward an inner surface layer.

7. The composite hollow fiber membrane according to claim 1, wherein the polymer resin film has a pore not more than 10 μm on its cross section.

8. The composite hollow fiber membrane according to claim 1, wherein the polymer resin film is prepared by polyethersulfone, polysulfone, or polyvinylidene difluoride.

9. A method for manufacturing a composite hollow fiber membrane comprising:
applying a heat treatment for a tubular reinforcement;
coating a polymer resin solution on a surface of a heat-treated tubular reinforcement; and
coagulating the polymer resin solution coated on the surface of the tubular reinforcement.

10. The method according to claim 9, wherein the heat treatment for the tubular reinforcement is carried out by a contact with a hot plate maintained at 110 to 230° C.

11. The method according to claim 9, wherein coating the polymer resin solution on the surface of the heat-treated tubular reinforcement is carried out through the use of a double tubular nozzle, wherein the double tubular nozzle comprises a central tube through which the tubular reinforcement 1 passes; and an outer tube through which the polymer resin solution passes, the outer tube being positioned in the circumstance of the central tube.

12. The method according to claim 11, wherein the tubular reinforcement is not more than 0.3 g/denier of delivery tension, just before passing through the central tube of the double tubular nozzle.

13. The method according to claim 9, further comprising cleaning the tubular reinforcement with a polymer resin film formed by the coagulating process.
